(19) United States
(12) Patent Application Publication
(10) Pub. No.: US 2015/0131285 A1
(43) Pub. Date: May 14, 2015

(54) Integrated Multiple Light Head

(71) Applicant: HeathCo, LLC, Bowling Green, KY (US)

(72) Inventor: Jonathan Arnold Lee, LaGrange, IL (US)

(21) Appl. No.: 14/509,577

(22) Filed: Oct. 8, 2014

Related U.S. Application Data
(60) Provisional application No. 61/901,726, filed on Nov. 8, 2013.

(51) Int. Cl. F21V 19/02; F21S 8/00

(52) U.S. Cl. CPC F21V 19/02; F21S 8/033; F21W 2131/107
USPC 362/249.11

(57) ABSTRACT

A lighting apparatus is configured to adjustably project light from multiple light sources. The lighting apparatus may include a fixture mountable to a mounting surface and a plurality of light heads. Each light head includes a light source and can have a perimeter surrounding a light projection surface, where the perimeter of each light head has at least one joining surface. One or more of the light heads are adjustable so that the lighting apparatus can be adjusted between a multi-directional configuration that projects light to at least two separate lighting areas, and a unified configuration that projects light to a single lighting area. The joining surfaces of each light head can be configured to substantially align, for example, so that the unified configuration establishes a unified light projection surface.

### RELATED APPLICATION

This application claims the benefit of U.S. Provisional application No. 61/901,726 filed Nov. 8, 2013, which is incorporated by reference in its entirety herein.

### TECHNICAL FIELD

The present disclosure generally relates to electrical lights. More specifically, the present disclosure relates to light sources having multiple adjustable light heads.

### BACKGROUND

Security lights provide lighting and illumination, and are typically used to improve visibility and security around the exterior of a building. Security lights are often positioned around doorways, and are particularly useful when installed around a doorway of a home or place of business. By illuminating doorways that would otherwise be dark, security lights can deter unwanted intruders and help homeowners identify approaching visitors.

Security lights typically employ one or more light heads mounted to a fixture that attaches to a structure such as a wall or pole, or to the ground. The light heads can be arranged such that light heads project light away from the fixture. For example, the light head can be a light source such as a light bulb or housing configured to hold a light source so that light projects out from the light head in a controlled direction to a preselected area.

Depending on the intended use, security lights may employ different configurations, arrangements, and appearances. Security lights can also vary in the number of light heads and/or light sources mounted on the fixture. For example, some security lights may use only a single light head that directs light in a single direction and/or to a single location. Such single-head security lights can be attractive as they offer the simple and clean look of a single light source. However, because single-head security lights have are only able to project light to a single area, they can be limited in the coverage area that they can illuminate.

Other security lights may employ two or more light heads that direct light to different areas, or that direct light to a common area but from different light projection positions. For example, some security lights may include two, three, or more light heads mounted on a fixture and spaced apart from one another. These light heads may be angled, moved, or otherwise adjusted so that they each project light to different locations. Because they have multiple light sources, these multi-head security lights can illuminate light in areas that a single-head security light cannot. Multi-head security lights, however, can be less attractive than the single-head counterparts by providing a busy and cluttered appearance. Further, in some configurations a multi-head security light may have an asymmetric or misaligned look with one light source arranged at a first angle, and a second light source arranged at a second, unrelated angle. This look can be particularly unattractive during daylight hours when the security light is not in use. Additionally, multi-head security lights can be burdensome to arrange, and may involve careful and constant adjustment of each of the light heads to assure that that each light is properly aimed at a desired location.

Based on the foregoing, installing security lights involves choosing between the lesser of two evils. That is, an installer will either select simple and attractive single light head with limited light coverage, or a less attractive multi-head security light that provides a broader range of illumination.

### SUMMARY

The present disclosure describes a lighting apparatus configured to adjustably project light from multiple light sources. In some aspects, the lighting apparatus includes a fixture mountable to a mounting surface, and a plurality of light heads. Each light head may have a light source and a perimeter surrounding a light projection surface, where the perimeter of each light head has at least one joining surface. One or more of the light heads is adjustable so that the lighting apparatus can be adjusted between a multi-directional configuration that projects light to at least two separate lighting areas, and a unified configuration that projects light to a single lighting area. In some embodiments, the joining surfaces of each light head are configured to substantially align. In this manner, the unified configuration can establish a unified light projection surface.

Other embodiments describe methods of projecting light from a lighting apparatus. The method may involve using one or more embodiments of a lighting apparatus described herein. For example, one method may involve a lighting apparatus having a fixture mountable to a mounting surface and a plurality of light heads. Each light head may have a light source and a perimeter surrounding a light projection surface, the perimeter of each light head having at least one joining surface. With this lighting apparatus, some embodiments of the method involve adjusting the light heads into a multi-directional configuration so that at least two light heads project to different lighting areas, and adjusting the light heads into a unified configuration to establish a unified light projection surface that projects light to a single location. In some aspects, the joining surfaces of each light head are configured to substantially align and establish a unified light projection surface in the unified configuration.

Some aspects of the present disclosure describe a security light configured to project light from multiple light sources. The security light can be arrangeable between a multi-directional configuration and a unified configuration. In some aspects, the security light includes a fixture mountable to a mounting surface. The security light can also include a first light head mounted to the fixture. The first light head can have a first light source and a first light projection surface with a first length (i.e., a length, width, height, depth, etc.). The security light can also have a second light head with a second light source, and a second light projections surface with a second length. The second light head can be linked to the first light head via a joint so that a position (e.g., a location, orientation, angle, etc.) of the second light head is adjustable relative to the first light head. The security light can also have a third light head with a third light source, and a third light projection surface having a third length. The third light head can be linked to the fixture via a joint so that a position of the third light head is adjustable relative to the first light head. In some aspects, the first light head, the second light head, and the third light head cam project light to three separate lighting areas, for example, when the security light is arranged in the multi-directional configuration. In some aspects, the first light projection surface, the second light projection surface and the third light projection surface form a single unified lighting surface that projects light to a single lighting area, for example, when the security light is arranged in the unified configuration. In some exemplary embodiments, the first length can be substantially equivalent to the sum of the second length and the third length.

### BRIEF DESCRIPTION OF THE DRAWINGS

FIG. 1 shows a front view of a lighting apparatus arranged in a unified configuration in accordance with at least one example of the present disclosure.

FIG. 2 shows a side view of the lighting apparatus of FIG. 1.

FIG. 3 shows a front view of the lighting apparatus of FIG. 1.

FIG. 4 shows a side view of the lighting apparatus of FIG. 3.

FIG. 5 shows a top view of the lighting apparatus of FIG. 1 with the upper light head removed.

FIG. 6 shows the exterior of a doorway with a lighting apparatus arranged in a unified configuration and projecting light in accordance with at least one example of the present disclosure.

FIG. 7 shows the exterior of a doorway with a lighting apparatus arranged in a multi-directional configuration and projecting light in accordance with at least one example of the present disclosure.

FIG. 8 is a flow diagram of a method in accordance with at least one example of the present disclosure.

### DETAILED DESCRIPTION

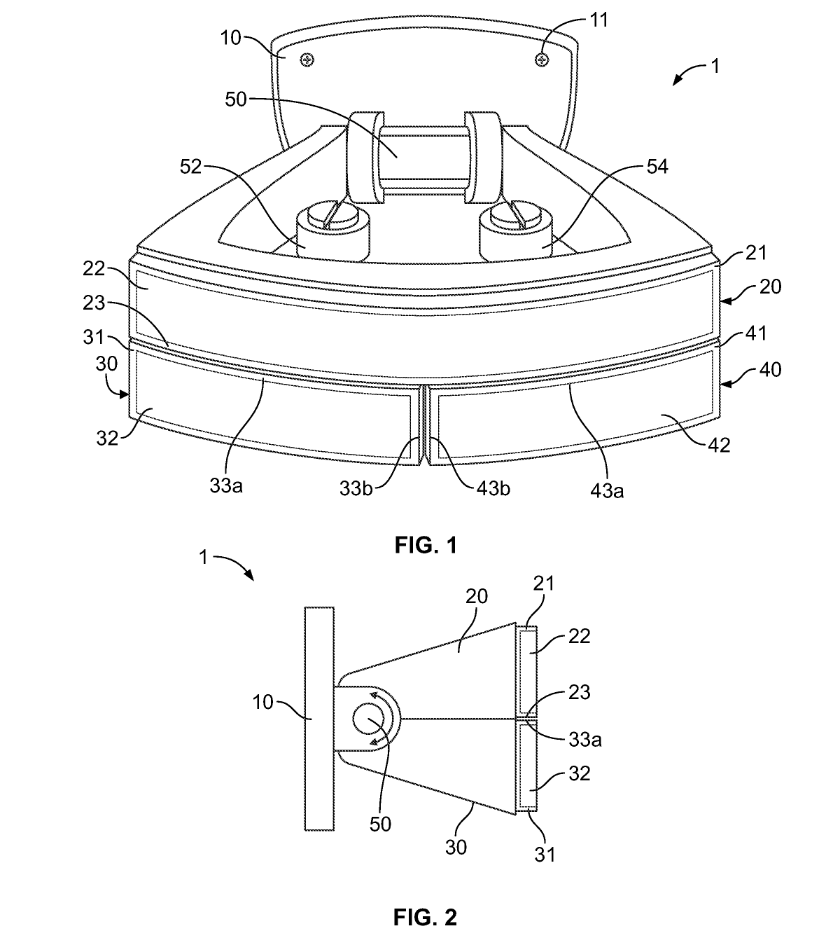

Referring to the figures, FIGS. 1-4 show examples of a lighting apparatus arranged in various configurations. The lighting apparatus can be, for example, a security light or other light source configured to project light to desired areas to provide increased visibility and added security. As used throughout this disclosure, it should be appreciated that the terms lighting apparatus and security light are interchangeable and can be used to define the same lighting device. Further, while the phrase “security light” can describe a light designed to provide added security to a location, the scope of the present described security light or lighting apparatus is not intended to be limited to such security enhancing devices. As used throughout this disclosure, the terms “lighting apparatus” and “security light” refer to any light projecting device that is mounted on or mountable to another surface, such as flood lights, spot lights, lanterns, or the like.

FIG. 1 shows an example of a security light 1 with multiple light sources arranged in a unified configuration. That is, FIG. 1 shows a security light 1 that appears to project light as if it were from a single light source. In the unified configuration, multiple light heads (or light housings) of the security light 1 are joined or united to form a single unified surface that can project light outward to a single lighting area. For example, in the unified configuration, the security light 1 can project light about a pathway leading to a doorway of a home, for example.

As shown in FIG. 1, the security light 1 can include a fixture 10, which can be, for example, a plate, block, bracket, post, stake, or other structure that is mountable or installable to a mounting surface. For example, in some embodiments, the fixture 10 can be a plate configured for mounting to a wall or the eaves of a home or building. In another example, the fixture 10 can be a stand that is configured for mounting, installing or otherwise being placed on or in the ground. In yet another example, the fixture 10 can be a bracket assembly or other structure that is configured for mounting to a pole or another non-flat surface. In some aspects, the fixture 10 may include a mounting mechanism 11 such as a hole, slot, groove, clip, bracket, or the like that facilitates the mounting of the fixture 10 to the mounting surface. For example, the mounting mechanism can be configured to allow the fixture 10 to be attached to a wall or other mounting surface via use of screws, nails, bolts, brackets, adhesives, or other mounting techniques.

The fixture 10 can be configured to allow one or more light heads to be attached thereto such that the light heads can project light away from the fixture 10. For example, as shown in FIG. 1, the fixture 10 includes an upper light head 20, and two lower light heads 30 and 40 mounted thereto.

In FIG. 1, the upper light head 20 is linked to the fixture by a joint 50. In some embodiments, the joint 50 can link the light head 20 or multiple light heads to the fixture 10, while enabling the light head(s) to move with at least one degree of freedom (e.g., up, down, left, right, in, out, or rotation about any axis) relative to the fixture 10. For example, the joint 50 may include one or more pin mounts that enable the light head(s) to rotate vertically and/or horizontally with respect to the fixture 10, or to spin about an axis perpendicular to the surface of the fixture 10. Additionally and/or alternatively, the joint 50 can include a ball and socket joint allowing rotation about two or more axes. In some embodiments, the joint 50 could also be a sliding joint such as a track, groove, slider, or the like, which can enable the position of the light heads to slide and/or move with respect to the fixture about one or more axes without affecting the angle of projection of the light. And in some embodiments, the joint 50 can a combination of two or more of the joints described herein.

In FIG. 1, and as further illustrated in FIG. 2 (showing shows a side view of the security light 1 in a unified configuration), the joint 50 is a pin mount configured to allow the upper light head 20 to rotate vertically with respect to the fixture 10. In this manner, the light heads of the security light 1 can rotate up and down, thereby allowing the light to be aimed for projecting light to various locations. In some embodiments, lower light heads 30 and 40 may be mounted to the upper light head 20, thereby enabling the entire lighting assembly rotate around the pin mount 50. With this mobility, a user can adjust how far away from the mounted location the light will reach from all three of the light heads.

The security light 1 can also include a lower left light head 30 and a lower right light head 40, each mounted to the upper light head 40 via joints 52 and 54, respectively. The joints 52 and 54 can take on various configurations and be of the types of joints described above; however, in FIG. 1, the joints 42 and 54 are shown as pin mounts that allow the lower light heads 30 and 40 to rotate horizontally with respect to the upper light head 20. In this manner, the lower left light head 30 can be rotated to the left, and lower right light head 40 can be rotated to the right, thereby establishing a multi-directional configuration that can project light to multiple different locations.

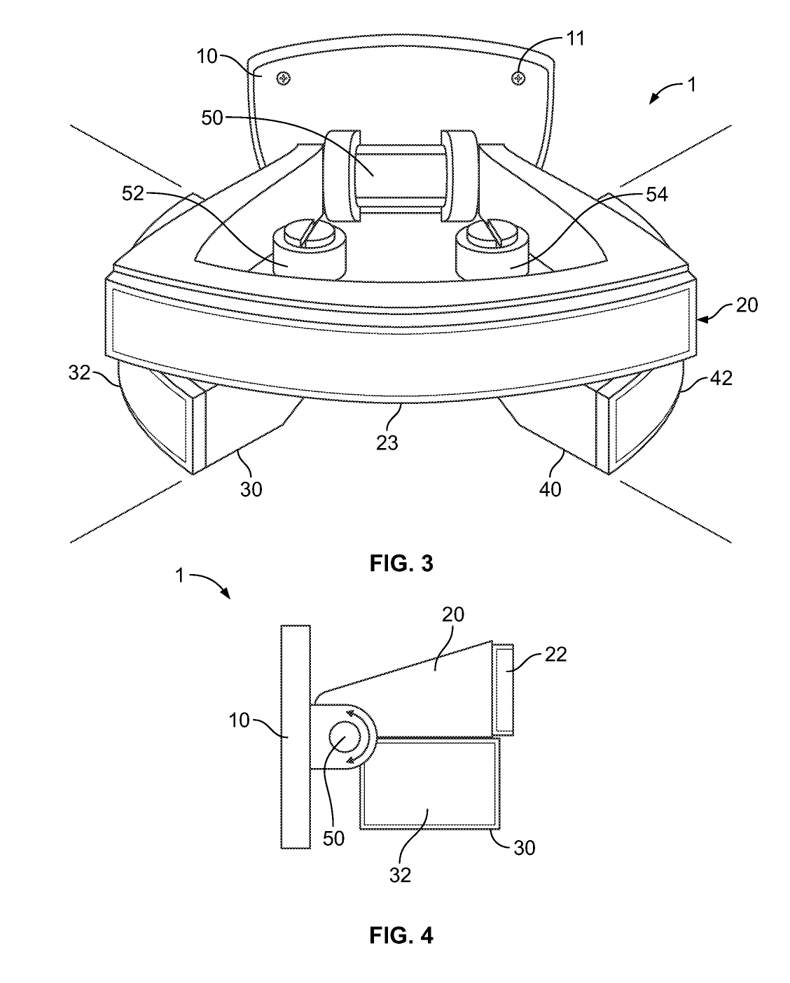

Examples of a security light 1 in a multi-directional configuration are shown in FIGS. 3 (showing a front view) and FIG. 4 (showing a side view) of a security light with the lower left light head 30 rotated to the left, and the lower right light head 40 rotated to the right. As demonstrated in FIGS. 3 and 4, when lower left light head 30 is rotated to the left, the lower right light head 30 will project light in a different direction and to a different location from that of upper light head 20 and lower right light head 40. Likewise, when lower right light head 40 is rotated to the right, the lower right light head 40 will project light in a different direction and to a different location from that of the upper light head 20 and the lower left light head 30. Thus, when rotated away from the unified configuration, the lower light heads 30 and 40 can establish a multi-directional configuration, whereby one or both of the lower left light head 30 and the lower right light head 40 project light to different locations from that of the upper light head, thereby illuminating multiple locations.

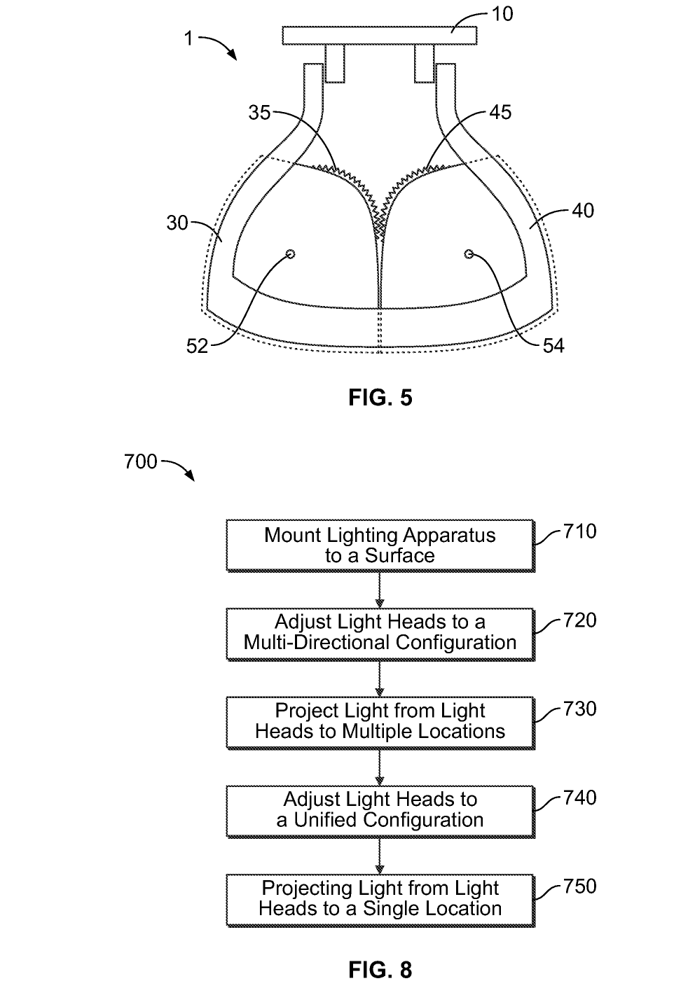

In some aspects, the joints 50, 52, and/or 54 can be linked (e.g., through gears or other mechanical devices) such that movement and/or rotation of one light head causes a corresponding movement and/or rotation of another light head. FIG. 5 shows one example of the light heads being linked in such a manner. FIG. 5 is a top view of the security light 1 with the upper light head 20 removed to show internal structure establishing the linkage of the light heads 30 and 40. In the depicted example, the left joint 52 is linked with the right joint 54 via gear teeth 35 and 45 on an interior surface on the lower left light head 30 and lower right light head 40. In this manner, rotation of the lower left light head 30 to the left causes a corresponding rotation of the lower right light head 40 to the right. Thus, the security light 1 can be configured so that the lower light heads 30 and 40 are generally symmetric with respect to the upper light head 20 while in the multi-directional configuration. In some embodiments, the joints of the security light can be linked so that rotation and/or movement of one light head causes a corresponding rotation and/or movement of two other light heads. For example, in some aspects, rotating the lower light head 30 to the left can cause the lower right light head 40 to rotate to the right, and the upper light head 20 to rotate upwards. In another example, the joints can be linked so that rotating the upper light head 20 up and/or down causes the lower left light head 30 to rotate to the left and the lower right light head 40 to rotate to the right.

In another example, the light heads and joints can be linked such that rotation and/or movement of one light head about a first axis or degree of freedom causes a corresponding movement and/or rotation of another light head, but rotation and/or movement about a second axis or degree of freedom does not affect the position of another light head. For example, the security light can be configured such that rotation of the lower left light head 30 to the left causes corresponding rotation of the lower right light head 40 to the right, but rotation of the lower left light head 30 in a downward direction has no impact on the position and/or orientation of the lower right light head 40. In another example, the security light may be configured so that adjusting the orientation or angle of the lower left light head 30 (e.g., via a pivot joint) results in a corresponding adjustment of the orientation or angle of the lower right light head 40, while sliding or moving the position of the lower left light head 30 to the left or right (e.g., via a sliding joint or track) does not affect the position of the lower right light head 40.

In some configurations, the security light can be equipped with electromechanical motors that adjust the position and/or orientation of the light heads automatically, for example, via a control switch or a remote control interface. In this manner, the security light 1 can be adjusted between unified and multi-directional configurations without a user interacting directly with the light heads. This can allow the security light to be installed in hard to reach locations, while still allowing the light heads to be adjustable between various configurations without the use of a ladder or pole, for example.

As shown in FIGS. 1-4, the security light 1 has a plurality of light heads (20, 30, and 40) which can each include a housing and a light source. For example, each light head can include a frame or housing (e.g., a can, a box, a shell, etc.) and a light bulb that is configured to project light away from the fixture when supplied with electrical power.

Each of the light heads may include a light projection surface through which the light source can project the light. For example, upper light head 20 includes an upper light projection surface 22 defined by a perimeter 21, or a border of the upper light head 20. The perimeter 21 can define a square or rectangular surface, and may include rounded or beveled edges, as shown in the Figures. However, alternative shapes and/or configurations can be used, provided that the shapes are configured to substantially align with the other light heads when in the unified configuration Likewise, lower left light head 30 also has a light projection surface 32 defined by a perimeter 31 or border, and lower right light head 40 has a lower left light projection surface 42 defined by a perimeter 41 or border.

Each of the perimeters (21, 31, and 41) includes at least one joining surface that is configured to substantially align with at least one other joining surface to establish a unified light projection surface of the unified configuration. For example, as shown in FIGS. 1 and 2, the upper light head 20 has a joining surface 23 on the lower region of the perimeter 21 defining the lighting surface 22. Lower left light head 30 has an upper joining surface 33a on the upper region of the perimeter 31, and a right joining surface 33b on the right region of the perimeter. Lower right light head 40 has an upper joining surface 43a on the upper region of the perimeter 41, and a left joining surface 43b on the left region of the perimeter. The joining surface 23 of the upper light head 20 is configured to substantially align with the upper joining surfaces 33a and 43a of the lower left and lower right light heads, respectively. Likewise, the right joining surface 33b of the lower left light head is configured to substantially align with the left joining surface 43b of the lower right light head 40. In this manner, the light heads 20, 30, and 40 can be brought together such that the lighting surfaces substantially establish a single or unified lighting surface of the security light.

While the joining surfaces can be configured to substantially align with each other, it is not necessary that the surfaces be configured to be brought together with no gaps or spaces therebetween as long as the security light appears to project light as if it is coming from a single light source when arranged in the unified configuration.

In some embodiments, the light projection surface of each light head has a length (as used throughout this application, the term “length” can refer to any one-dimensional measurement, for example, length, width, depth, height, etc.) that corresponds to a length of one or more other light heads. For example, in FIG. 1 the light projection surface 22 of the upper light head 20 has a first length that extends from the left edge to the right edge of the perimeter 21. The light projection surface 32 of the lower left light head 30 has a second length that extends from the left edge to the right edge of the perimeter 31. Likewise, the light projection surface 43 of the lower right light head 40 has a third length that extends from the left edge to the right edge of the perimeter 41. In this manner, the first length is substantially equivalent or equal to the sum of the second length and the third length. In some embodiments, the second length and the third length are substantially equivalent or equal, and the first length is substantially equivalent to twice the second or third length.

By configuring the lengths of the light projection surfaces to correspond with one another, the security light 1 can have a unified light projection surface that takes on an aesthetically pleasing or symmetric shape. While the unified configurations shown in the Figures illustrate a generally rectangular shape for the unified light projection surface, it should be appreciated that various shapes and configurations can be used as long as the unified surface appears to be a single, unified light source in operation. For example, the shapes and lengths of the light heads can be configured so that the unified surface forms the shape of a square, a triangle, a diamond, a pentagon, a circle, an oval, a hemisphere, a ring, or a donut shape.

In some embodiments, the light projection surfaces of the light heads can have curved surfaces. For example, as shown in FIGS. 1-4, the light projection surfaces 22, 32, and 42 of the light heads 20, 30, and 40 form a generally curved surface, such that they form a segment of a cylinder or a sphere. In this manner, the curves of each light head can be substantially matched and/or aligned such that the unified configuration establishes a curved unified light projection surface, as demonstrated, for example, in FIGS. 1 and 2.

FIGS. 1-5 show a security light 1 having three light heads, for example, upper light head 20, and lower light heads 30 and 40. It should be appreciated, however, that security lights can be configured with more or fewer light heads, provided that the light heads are adjustable between a multi-directional configuration that projects light to multiple lighting areas, and a unified configuration that projects light to a single lighting area. For example, in some embodiments, a security light can include two light heads, four light heads, five light heads, eight, or ten light heads, provided that the light heads can be brought together into a unified configuration that establishes a single unified light projection surface. In this manner, each light head can include a light projection surface defined by a perimeter that has at least one joining surface that is configured to substantially align with at least one other joining surface of another light head so that the unified configuration can establish a generally unified light projection surface.

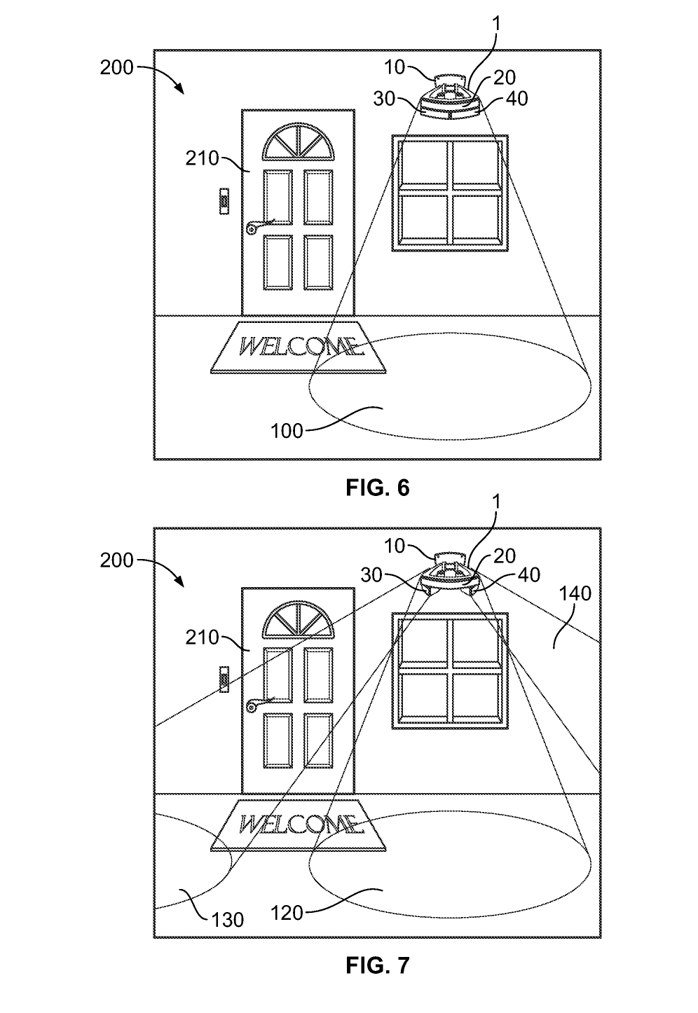

In operation, the security light 1 described herein can be installed at various locations about a doorway to provide added lighting and visibility, and increased security to desired locations. FIGS. 6 and 7 provide examples of a security light 1 installed at a doorway of a home in various configurations. More specifically, FIG. 6 shows a security light 1 arranged in a unified configuration and installed to the right of a door 210 at a home entrance 200. As shown, the upper light head, and the two lower light heads 30 and 40 are substantially aligned and establish a unified light projection surface, which illuminates a single lighting area 100. Because multiple light sources are combined to generate light from the unified configuration, the illuminated lighting location of the unified light projection surface can be wider or broader than the lighting locations illuminated from the multi-directional configuration. This unified configuration can also produce focused and even intensified light.

FIG. 7 shows a security light 1 arranged in a multi-directional configuration installed to the right of a door 210 at a home entrance 200. In this embodiment, the lower left light head 30 has been rotated to the left and is thus angled to project light to a location 130 to the left of the door 210. Lower right light head 40 has been adjusted to the right and angled to project light to another lighting area 140 to the right of the figure. Upper light head 120 projects light to a location 120 in front of the door 210. In this manner, each of the lighting areas (120, 130, and 140) illuminated from the multi-directional configuration are different from the area 100 illuminated from the unified configuration as shown in FIG. 5.

Certain aspects of the present disclosure also include methods of projecting light from a lighting apparatus. FIG. 8 is a flow diagram of an example method 700 for projecting light from a lighting apparatus. The method 700 can include, at step 710, mounting a lighting apparatus to a surface, such as a wall, the ground, or a pole, for example. The lighting apparatus can be a security light described herein with respect to FIGS. 1-6. For example, the lighting apparatus can have a fixture that is mountable to a mounting surface and a plurality of light heads. Each light head can have a light source (e.g., a light bulb, LED, and the like) and a perimeter defining a light projection surface, the perimeter of each light head having at least one joining surface.

Step 710 can include installing a fixture of a lighting apparatus onto a wall, for example, using screws, nails, brackets, pins, adhesives, or other mounting techniques. In some embodiments, the lighting apparatus can be mounted to an eve of a building as a highly functional, particularly for corner mount. For example, the lighting apparatus can be mounted at a 45° angle with respect to the corner of the building to both directs the upper light head out from the corner, and also allow the lower light heads to extend the ark of the light to cover the corner.

Once mounted, the light heads of the lighting apparatus can be adjusted into a multi-directional configuration and/or a unified configuration. For example, at step 720, the light heads can be arranged to point in different directions and/or to different locations, thereby establishing a multi-directional configuration of the lighting apparatus. In some embodiments, adjusting one light head can result in a corresponding adjustment of another light head, as described herein. In certain examples, the adjustment of the light heads can be accomplished by a control unit, or a remote control device, whereby pressing a button or initiating a control switch transmits a signal that results in an electromechanical adjustment of the light heads.

At step 730, the light sources of the light heads are turned on to project light from the multi-directional configuration. Because the light heads are pointed to different locations when arranged in the multi-directional configuration, step 730 projects lights to multiple lighting locations. For example, as shown in FIG. 7, step 730 can result in light being projected to multiple different areas around a doorway.

At step 740, the lighting apparatus is arranged into a unified configuration. As disclosed herein, the unified configuration substantially aligns the joining surfaces of the light heads to create a generally unified light projection surface that appears to project light from a single light source when turned on. It should be noted that while step 740 is described as occurring after step 720, the order of these two steps are of no particular significance to the method. That is, the arrangement of the light heads into the unified configuration of step 740 can occur before the arrangement of the light heads into the multi-directional configuration of step 720 without departing from the spirit of the described method. As with step 720, the arrangement of the light heads at step 740 can occur by adjusting one or more light heads manually, or by using a control unit.

At step 750, light is projected from the light heads arranged in the unified configuration. In this step, because the light heads are arranged to establish a unified light projection surface, step 750 projects light to a single lighting location. Because multiple light sources are combined to generate light from the unified configuration, the illuminated lighting location of the unified light projection surface can be wider or broader than the lighting locations illuminated from the multi-directional configuration.

The present disclosure now describes a lighting apparatus and related methods that offer an improved integrated security light design, thereby allowing the light heads to be adjusted to function as both a single light source device (e.g., in the unified configuration), and as a multi-light source device (e.g., in the multi-directional configuration). Another aspect of the present disclosure provides a device and techniques that make adjustment of multiple light heads easier and more convenient by enabling the adjustment of multiple light heads based on the adjustment of a single light head.

The present disclosure describes preferred embodiments, aspects, and examples of the present technology. Reference throughout this specification to “one embodiment,” “one aspect,” “one example,” or similar language means that a particular feature, structure, or characteristic described in connection with the embodiment is included in at least one embodiment, aspect, or example of the present invention. The embodiments shown in the drawings, if any, and as described above are merely for illustrative purposes and not intended to limit the scope of the invention. Moreover, those skilled in the art will recognize that a wide variety of modifications, alterations, and combinations can be made with respect to the above described embodiments without departing from the scope of the invention as set forth in the claims, and that such modifications, alterations, and combinations are to be viewed as being within the ambit of the inventive concept. Thus, appearances of the phrases “in one embodiment,” “in one aspect,” “in one example,” and similar language throughout this specification may, but do not necessarily, refer to the same embodiment. Further, it will also be understood that the terms and expressions used herein have the ordinary meaning as is accorded to such terms and expressions by persons skilled in the field of the invention as set forth above, except where specific meanings have otherwise been set forth herein. All references cited in the present disclosure are hereby incorporated by reference in their entirety.

1) A lighting apparatus configured to adjustably project light from multiple light sources, the lighting apparatus comprising:
a fixture mountable to a mounting surface; and
a plurality of light heads, each light head having a light source and a perimeter surrounding a light projection surface, the perimeter of each light head having at least one joining surface;
wherein a position of at least one light head is adjustable so that the lighting apparatus is adjustable between a multi-directional configuration that projects light to at least two separate lighting areas, and a unified configuration that projects light to a single lighting area, and
wherein the joining surfaces of each light head are configured to substantially align so that the unified configuration establishes a unified light projection surface.

2) The lighting apparatus of claim 1, further comprising at least one joint linking a light head of the plurality of light heads to the fixture, the joint configured to enable the linked light head to move with at least one degree of freedom relative to the fixture.

3) The lighting apparatus of claim 2, further comprising a plurality of joints linking individual ones of the plurality of light heads to the fixture.

4) The lighting apparatus of claim 3, wherein at least one joint of the plurality of joints links a light head to another light head of the plurality of light heads.

5) The lighting apparatus of claim 1, wherein at least one light head of the plurality of light heads has a curved light projection surface.

6) The lighting apparatus of claim 5, wherein each light head of the plurality of light heads has a curved light projection surface, and wherein the curves of each light projection surface are substantially matched so that the unified configuration establishes a curved unified light projection surface.

7) The lighting apparatus of claim 1, wherein the plurality of light heads consists of a first light head, a second light head, and a third light head.

8) The lighting apparatus of claim 7, wherein the third light head has a length that is substantially equivalent to the sum of a length of the second light head and a length of the third light head.

9) The lighting apparatus of claim 8, wherein the first, second, and third light heads have curved surfaces that are substantially matched so that the alignment of the light heads forming the unified configuration establishes a curved unified light projection surface.

10) The lighting apparatus of claim 1, wherein the light heads are configured so that adjusting a position of a first light head results in a corresponding adjustment to a position of a second light head.

11) The lighting apparatus of claim 10, wherein the light heads are configured so that adjusting the position of the first light head results in a corresponding adjustment to the position of the second light head and a third light head.

12) The lighting apparatus of claim 1, wherein the light heads are configured so that adjusting a position of a first light head about a first axis results in a corresponding adjustment to a position of a second light head, and adjusting the position of the first light head about a second axis has no effect on the position of the second light head.

13) A method of projecting light from a lighting apparatus, the lighting apparatus having a fixture mountable to a mounting surface and a plurality of light heads, each light head having a light source and a perimeter surrounding a light projection surface, the perimeter of each light head having at least one joining surface, the method comprising:
adjusting the light heads into a multi-directional configuration so that at least two light heads project to different lighting areas, and
adjusting the light heads into a unified configuration to establish a unified light projection surface that projects light to a single location,
wherein the joining surfaces of each light head are configured to substantially align so that the unified configuration establishes a unified light projection surface.

14) The method of claim 13, further comprising adjusting a position of a first light head of the plurality of light heads, which adjusting automatically results in a corresponding adjustment of a position of a second light head.

15) The method of claim 13, further comprising adjusting a position of a first light head of the plurality of light heads about a first axis, which adjusting automatically results in a corresponding adjustment to a position of a second light head, and adjusting the position of the first light head about a second axis, which adjusting has no effect on the position of the second light head.

16) A security light configured to project light from multiple light sources and arrangeable between a multi-directional configuration and a unified configuration, the security light comprising:
a fixture mountable to a mounting surface;
a first light head mounted to the fixture, the first light head having a first light source and a first light projection surface having a first length;
a second light head having a second light source and a second light projection surface having a second length, the second light head linked to the first light head via a first joint so that a position of the second light head is adjustable relative to the first light head; and
a third light head having a third light source and a third light projection surface having a third length, the third light head linked to the first light head via a second joint so that a position of the third light head is adjustable relative to the first light head;
wherein the first light head, the second light head, and the third light head project light to three separate lighting areas from the multi-directional configuration,
wherein the first light projection surface, the second light projection surface, and the third light projection surface are mounted to be able to be arranged to form a single unified lighting surface that projects light to a single lighting area from the unified configuration, and
wherein the first length is substantially equivalent to a sum of the second length and the third length.

17) The security light of claim 16, wherein the position of the first light head is adjustable with respect to the fixture.

18) The security light of claim 16, wherein the first, second, and third light have curved light projection surfaces that are substantially matched so that the alignment of the light forming the unified configuration establishes a curved unified light projection surface.

19) The security light of claim 16, wherein the second and third light heads are configured so that adjusting the position of the second light head results in a corresponding adjustment of the position of the third light head.

20) The security light of claim 16, wherein the light heads are configured so that adjusting a position of a first light head about a first axis results in a corresponding adjustment to a position of a second light head, and adjusting the position of the first light head about a second axis has no effect on the position of the second light head.
